(19) United States
(12) Patent Application Publication
(10) Pub. No.: US 2002/0166019 A1
(43) Pub. Date: Nov. 7, 2002

(54) Method and apparatus for interfacing a bus with an external device

(76) Inventors: Leesa Noujeim, Sunnyvale, CA (US); Brian Verstegen, Sunnyvale, CA (US); Erich Selna, Sunnyvale, CA (US)

Correspondence Address: Terry D. Morgan Esq, WILLIAMS MORGAN & AMERSON P C, Suite 250, 7676 Hillmont, Houston, TX, 77040, US

(21) Appl. No.: 09/846,959

(22) Filed: May 1, 2001

(51) Int. Cl. G06F 13/38

(52) U.S. Cl. 710/301

(57) ABSTRACT

A method for controlling a bus is provided. In particular, an external device may be interfaced with a bus internal to a computer system. The method involves detecting when a device is coupled to the bus, and driving signals onto the bus in response to detecting the device being coupled to the bus. Alternatively, when the external device is not coupled to the bus, the signals are blocked, disabled, or otherwise prevented from being delivered onto the bus.

### BACKGROUND OF THE INVENTION

1. FIELD OF THE INVENTION

This invention relates generally to expanding the capabilities of a computer system, and, more particularly, to interfacing an external module with an internal bus of a computer system.

2. DESCRIPTION OF THE RELATED ART

Historically, computer systems are general purpose devices that may be modified to perform particular tasks or functions. Generally, computer systems include a motherboard mounted in a cabinet. The motherboard typically includes a number of connectors or slots in which special purpose printed circuit boards may be inserted. These special purpose printed circuit boards may be used to add to or enhance the functionality of the computer system. For example, a conventional computer system may have its graphics capability enhanced by the addition of a graphics card. Similarly, the sound producing capability of the computer system may have its graphics capability enhanced by the addition of a graphics card.

One limitation on the ability to add to or enhance the functionality of the computer system is the number of slots or connectors that are provided. For example, if a user desires to enhance both sound and graphics capability, but only a single slot or connector is available, then the user must select the more desirable function or alternate between the cards, as needed. Neither solution is particularly desirable.

In some computer systems, additional functionality is provided on the motherboard itself. That is, the motherboard may be designed with electrical leads or traces formed therein to provide interconnectivity to a special purpose circuit. The integrated circuits used to perform the functionality of the special purpose circuit may only be included on select motherboards where the customer has ordered the special purpose circuit. Typically, this approach is used so that a manufacturer may design a single motherboard that is used in a variety of computer systems to achieve economies of scale in manufacturing the motherboard. However, the real estate on the motherboard is “wasted” in those computer systems that do not use the special purpose circuit. For example, it may be desirable to have additional microprocessors to provide a high-end computer system capable of performing more intense processing in some applications. Thus, the motherboard may be designed to accept multiple microprocessors, but only a single microprocessor is actually placed in the motherboard unless the customer requests additional microprocessors. Thus, in those systems in which only a single microprocessor is installed, valuable motherboard real estate is unused and performing no useful work for the computer system.

Further, a computer system typically includes a single power supply with a preselected capacity (e.g., 300 watts). The capacity of the power supply is selected based on the expected power requirements of the computer system at the time that it is manufactured.

Thus, if additional or enhanced functionality is provided, the capacity of the power supply may be inadequate. On the other hand, if a large capacity power supply is originally installed, but additional or enhanced functionality is not provided, then the extra capacity of the power supply is “wasted.”

Some prior devices have suggested adding or enhancing functionality through an external connection to the computer system. This solution suffers from a variety of mechanical and electrical challenges, such as providing secure and high quality electrical connections, difficulty of assembly, electromagnetic interference, cooling, and the like. Additionally, for these external devices to operate efficiently, they need to have a high-speed connection to the computer system, such as through a peripheral component interface (PCI) bus, an industry standard architecture (ISA) bus, a proprietary bus, a system bus, or the like. Extending a high-speed bus external to the cabinet of the computer system can create substantial difficulties. For example, a high-speed bus is sensitive to the length of the traces used to form the bus. Extending the bus will, of course, change the length of the traces, creating the potential for reflections and other interference anomalies on the extended bus. Further, timing difficulties may also arise from the extended distance that the signals must travel on the extended bus.

The present invention is directed to overcoming, or at least reducing the effects of, one or more of the problems set forth above.

### SUMMARY OF THE INVENTION

In one aspect of the present invention, a method is provided for controlling a bus. The method comprises detecting a device coupled to a bus; driving signals onto the bus in response to detecting the external device being coupled to the bus; and blocking signals from being delivered onto the bus in response to the absence of the device being coupled to the bus.

In another aspect of the present invention, an apparatus is provided for controlling a bus. The apparatus is comprised of a first and second printed circuit board coupled together via first and second edge connectors and a repeater mounted on the first printed circuit board. The first printed circuit board has at least one electrically conductive line extending to the first edge connector. The repeater is electrically coupled to the electrically conductive line, and is comprised of a transmitter having an enable input terminal and an output terminal. The enable input terminal is coupled to the at least one electrically conductive line on the first printed circuit board. The second printed circuit board has a second edge connector adapted to mate with the first edge connector, wherein at least one terminal of the second edge connector is coupled to a preselected voltage level and to the enable input terminal of the transmitter via the electrically conductive line to enable the transmitter in response to the first and second edge connectors being coupled together.

### BRIEF DESCRIPTION OF THE DRAWINGS

The invention may be understood by reference to the following description taken in conjunction with the accompanying drawings, in which the leftmost significant digit(s) in the reference numerals denote(s) the first figure in which the respective reference numerals appear, and in which:

FIG. 1 illustrates a stylized representation of a computer system that may advantageously employ one or more of the aspects of the present invention;

FIG. 2 schematically illustrates one embodiment of a top level block diagram of the computer system of FIG.1;

FIG. 3 schematically illustrates a block diagram of a motherboard, backplane, and external device of the computer system of FIGS. 1 and 2;

FIG. 4 illustrates a block diagram of select interconnections between the motherboard, backplane, and external device of FIG. 3; and

FIG. 5 illustrates a diagram of a portion of a driver circuit contained within a repeater of FIGS. 3 and 4.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but, on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

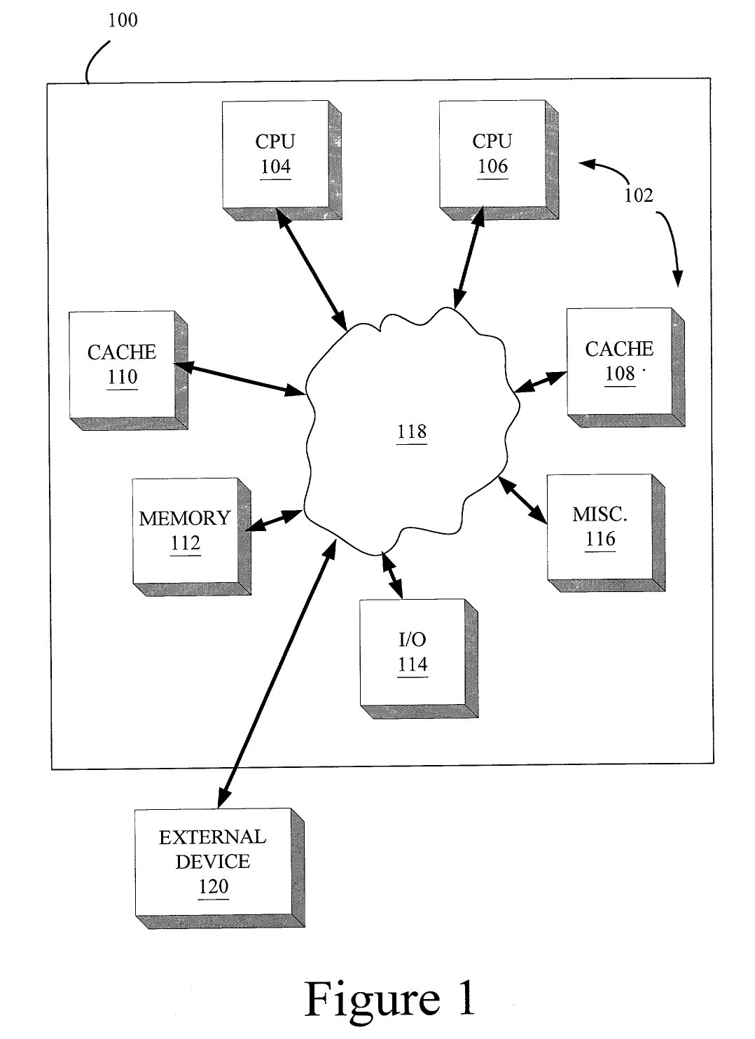

Illustrative embodiments of a method and apparatus for providing a high-speed bus connection to an external device according to the present invention are shown in FIGS. 1-6. As will be readily apparent to those skilled in the art upon a complete reading of the present application, the present method and apparatus are applicable to a variety of computer systems other than the embodiment illustrated herein, and moreover to electronic devices other than computer systems, including, but not limited to, logic devices, memory devices, and the like.

Turning now to FIG. 1, a stylized representation of a computer system 100 that may advantageously employ one or more of the aspects of the present invention is shown. Generally, the computer system 100 is comprised of exemplary components 102, such as a first and second central processing unit (CPU) 104, 106, a first and second cache 108, 110, a memory 112, input/output (I/O) 114, and other miscellaneous components 116, such as a sound card, a video card, and the like. These components 102 are coupled together via an architecture 118, which allows the components 102 to efficiently communicate with one another and potentially with other external devices (not shown), such as other computer systems, printers, scanners, etc. Additionally, a device 120 may be located physically external to the computer system 100, such as outside of a housing or case that contains the computer system 100, but may functionally operate as part of the computer system 100 by virtue of a high-speed connection to the computer system.

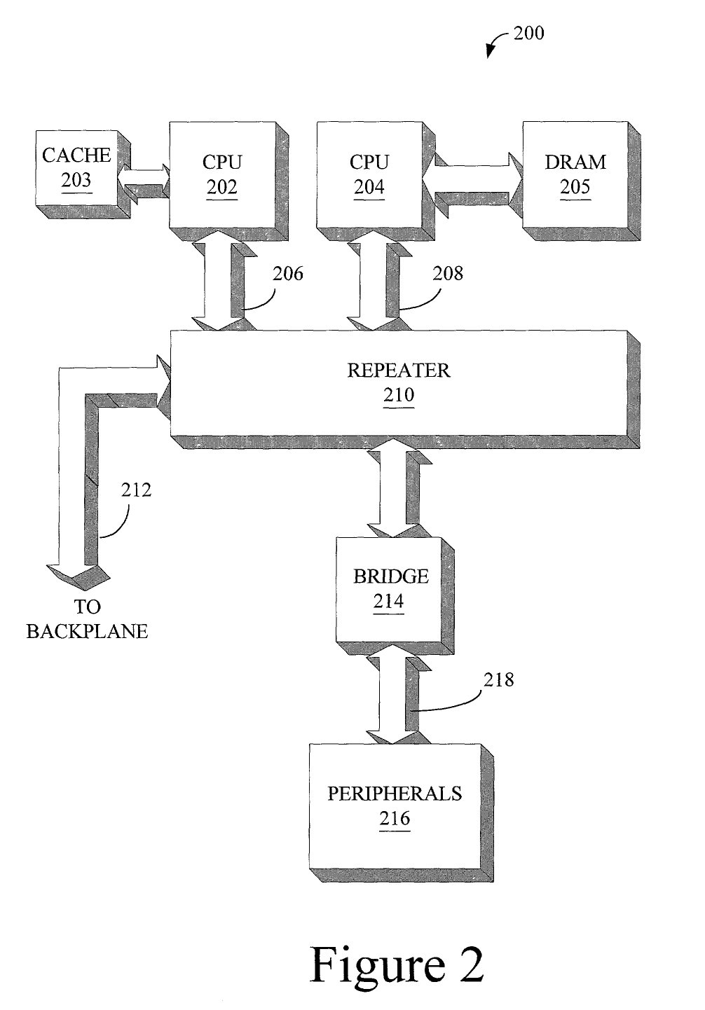

The architecture 118 may take on any of a variety of forms without departing from the spirit and scope of the instant invention. To illustrate various aspects of the instant invention, the implementation of the invention in an exemplary architecture is shown beginning in FIG. 2. However, the instant invention admits to much wider application and should not be considered as being limited to the particular architecture 118 illustrated herein unless specifically set forth in the appended claims.

FIG. 2 illustrates a top-level block diagram of one embodiment of a computer system 200 that may advantageously employ one or more aspects of the present invention. The computer system 200 may comprise a pair of central processing units (CPUs) 202, 204, such as UltraSPARC™ or MicroSPARC™ microprocessors commercially available from Sun Microsystems. Those skilled in the art, having benefit of the accompanying specification, will appreciate that the present invention has application in a variety of computer systems, including single and multiple CPU systems. In the illustrated embodiment, the first and second CPUs 202, 204 each have at least one, and in some cases more than one, type of memory associated with them. The memory may take the form of dynamic random access memory (DRAM) 205, a cache 203, both, multiple levels of each, or some combination thereof. Generally, the memory is used by the CPUs 202, 204 during normal operation for temporary storage of data and/or instructions.

The CPUs 202, 204 are coupled to substantially similar input ports of a repeater 210 over processor buses (or JBUSes) 206, 208, respectively. As its name suggests, the function of the repeater 210 is to receive signals over one of the buses 206, 208 and repeat or deliver those same signals over the other one of the buses 206, 208. In this way, the CPUs 202, 204 communicate with one another. In an embodiment of the computer system 200 that includes more CPUs, such as a four CPU system, the repeater 210 operates to repeat or deliver the signals from one CPU to all of the other CPUs even if the signals are not directed to all of the other CPUS. This “broadcasting” of signals to all of the CPUs ensures that all of the CPUs receive all of the signals initiated by each CPU. The CPUs are individually responsible for determining which of the received signals are intended for or of interest to it. The repeater 210 sequentially responds to signals delivered by each of the CPUs and broadcasts those signals to all of the other CPUs so that each CPU can communicate with every other CPU.

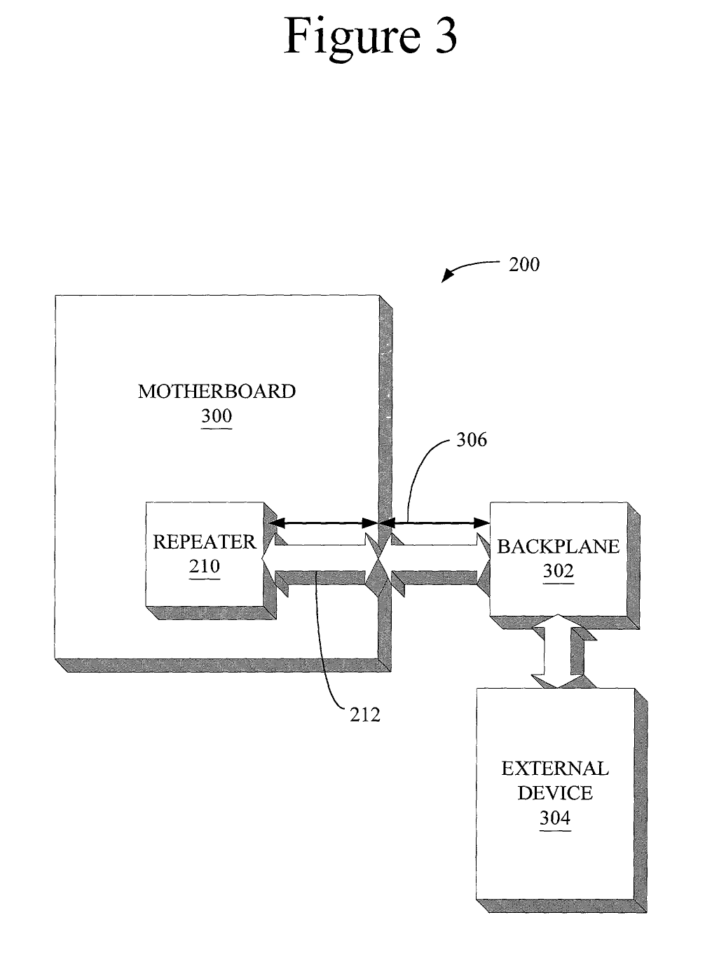

The repeater 210 includes an additional port coupled to a bus 212. The additional port is substantially similar to the ports coupled to the buses 206, 208. Generally, the additional port functions substantially similar to the ports coupled to the processors 202, 204, with one exception being that it may be disabled or otherwise prevented from repeating or delivering signals generated by the processors 202, 204 onto the bus 212 under select operating conditions. As discussed in more detail in conjunction with FIGS. 3-6, the repeater 210 may be enabled to repeat or deliver signals onto the bus 212 when an external device is coupled to the bus 212. Conversely, the repeater 210 may block, disable, deactivate or otherwise prevent signals from being repeated or delivered onto the bus 212 when no external device is coupled to the bus 212.

In the illustrated embodiment, the bus 212 is a terminated bus, with termination being effected by the external device when it is coupled to the bus 212. Thus, when the external device is not coupled to the bus 212, termination of the bus is not effective, and cross talk, reflections, or other signal anomalies may occur on the bus 212 if the repeater 210 drives signals onto it in the absence of proper termination. Accordingly, as discussed in more detail below, the repeater 210 detects the presence/absence of an external device coupled through the backplane 212 and drives/blocks signals, as appropriate.

A conventional bridge 214 interfaces a plurality of peripheral devices 216 with the CPUs 202, 204 and/or the external device through the repeater 210. Generally, the peripheral devices 216 are of a type designed to communicate over a bus 218 of a preselected type different from the buses 206, 208, 212. For example, the bus 218 may take the form of a conventional peripheral component interface (PCI) bus, an industry standard architecture (ISA) bus, a proprietary bus, or the like. Generally, the bridge 214 interfaces the different standards used by the buses 206, 208, 212 and the bus 218 so that they may allow the CPUs 202, 204 to communicate with the peripherals 216, or vice versa.

Turning now to FIG. 3, one embodiment of a portion of the computer system 200 is shown stylistically interfaced with an external device 304 via the repeater 210. The repeater 210 is illustrated as being mounted on a motherboard 300 located within the computer system 200. Those skilled in the art will appreciate that the repeater 210 need not be mounted directly on the motherboard 300, but could be electrically coupled thereto while being physically mounted on a daughtercard or other separate printed circuit board (not shown). In the illustrated embodiment, the repeater 210 is coupled through the bus 212 to a conventional edge connector (not shown) coupled to the motherboard 300. A mating edge connector (not shown) is mounted on a backplane 302 and extends between the external device 304 and the edge connector on the motherboard 300. The backplane 302 operates, at least partially, as a physical and electrical interface between the external device 304 and the repeater 210.

A detailed description of one embodiment of a physical interface and mounting arrangement for accurately and repeatably positioning and assembling the computer system 200 with the backplane 302 and the external device 304 may be found in a co-pending United States patent application entitled “MODULAR COMPUTER SYSTEM AND METHOD” by Erich Selna et al., which is filed contemporaneously herewith and is subject to common assignment herewith. This co-pending application is hereby incorporated by reference in its entirety.

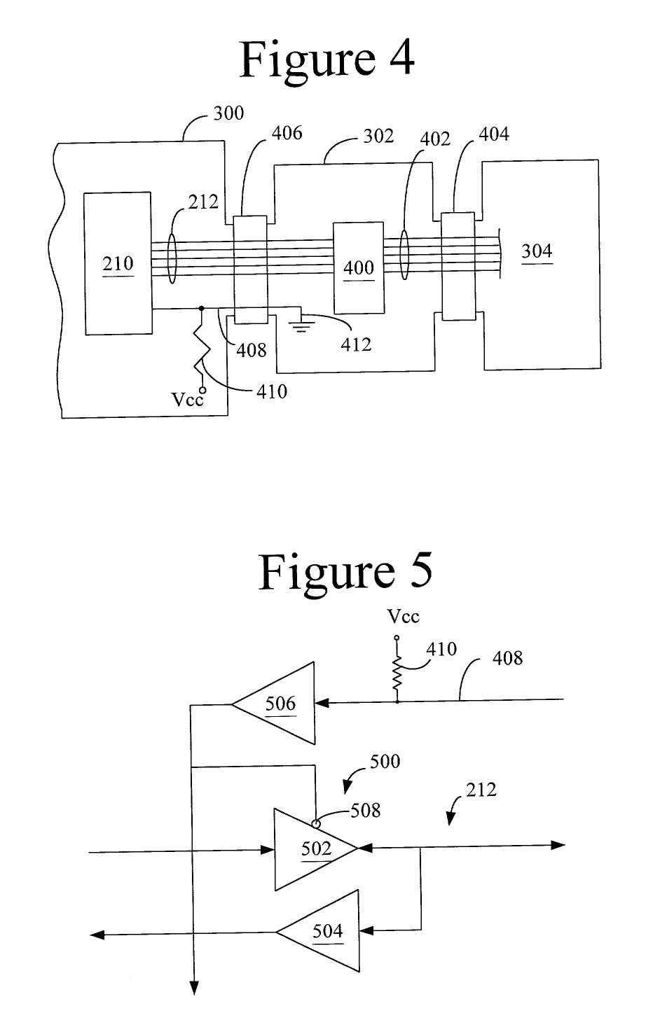

As shown in FIG. 4, the backplane 302 includes a bridge 400 that operates to interface the bus 212 with a bus 402. The bus 402 extends to the external device 304 through a set of conventional connectors, such as edge connectors 306. Thus, the external device 304, which is designed to communicate using a preselected bus protocol, communicates with the bus 212 via the bridge 400. In the illustrated embodiment, the bus 212 is a processor bus (or JBUS) and the bus 402 may be a PCI bus, an ISA bus, a proprietary bus, or the like. The bridge 400 may take the form of a conventional bridge substantially similar to the bridge 214.

Those skilled in the art will appreciate that the external device 304 could take any of a variety of forms, including conventional devices ordinarily located within a computer system, such as conventional video cards, sound cards, network interface cards, magnetic and optical disk drives, and the like that include an interface designed to be operated with a PCI bus, an ISA bus, a proprietary bus, or the like.

On the other hand, the external device 304 may be a custom designed device that uses a conventional or custom bus interface protocol and corresponding bridge circuit. Custom external devices 304 need not be limited to the form factor of PCI and ISA bus devices. That is, the custom external devices 304 need not be designed to fit within the conventional housing or chassis of a conventional computer system, but rather, may be enlarged or reduced in size as needed to accommodate the attendant circuitry. For example, very high-end graphics cards originally designed for installation in a high-end workstation may be coupled to a conventional computer system through the backplane and mounted external to the device even though they are substantially larger than the form factor required to fit within a conventional computer system housing, case, or chassis.

The instant invention permits a designer to couple any of a variety of devices to a conventional computer system regardless of whether the computer system was originally designed to physically or electrically accommodate the device. For example, the computer system need not be designed to support ISA type devices, as many end users do not use ISA type devices. However, using the instant invention, ISA type devices could still be later added to the system through the appropriate backplane.

To eliminate, or at least reduce, cross talk, reflections, or other signal anomalies that may occur on the bus 212 when no backplane 302 or external device 304 is coupled to the motherboard 300, the repeater 210 is configured to recognize their absence and not drive signals onto the bus 212. The presence/absence of the backplane 302 and external device 304 is signaled to the repeater 210 by a signal line 408 that extends to the edge connector 406 on the motherboard 300. The signal line 408 includes a pull-up resistor 410 coupled to a voltage source Vcc, such that a logically high signal is normally delivered to the repeater 210 when the backplane 302 is not electrically/physically coupled to the motherboard 300. However, when the backplane 302 is coupled to the motherboard 300, the signal line 408 is coupled to system ground via a line 412, pulling the line 408 to a logically low level. The logically low signal indicates to the repeater 210 that the backplane 302 and the external device 304 are now coupled to the motherboard 300. The repeater 210 responds to the logically low signal by driving signals onto the bus 212 so that communications with the external device 304 may be accomplished.

Each line in the bus 212 has a substantially identical driver 500 associated with it in the repeater 210. Accordingly, for ease of illustration, only a single one of the drivers 500 is illustrated in FIG. 5. The driver 500 includes a transmit buffer 502 and a receive buffer 504 respectively having their output terminal and input terminal coupled to one of the lines in the bus 212. A signal driven onto the bus 212 by the repeater 210 will pass through the transmit buffer 502, whereas a signal driven onto the bus 212 by the bridge 400 (see FIG. 4) will pass through the receive buffer 504. The transmit and receive buffers 502, 504 allow the bus 212 to be bi-directional.

The transmit buffer 502 includes an enable input terminal 508 that is coupled to the line 408 through a buffer 506. The buffer 506 drives a signal representing the logical status of the line 408 to the enable input terminal 508 of the transmit buffer 502. That is, when the backplane 302 and the external device 304 are not physically and electrically coupled to the motherboard 300, the pull up resistor 410 produces a logically high signal at the input terminal of the buffer 506. The buffer 506 delivers the logically high signal to the enable input terminal 508 of the transmit buffer 502, which disables the transmit buffer 502 from delivering a signal onto the line of the bus 212. In contradistinction thereto, when the backplane 302 and the external device 304 are physically and electrically coupled to the motherboard 300, the ground connection from the line 412 produces a logically low signal at the input terminal of the buffer 506. The buffer 506 delivers the logically low signal to the enable input terminal 508 of the transmit buffer 502, which enables the transmit buffer 502 to deliver a signal onto the line of the bus 212. In this manner, the bus 212 is disabled when the backplane 302 and the external device 304 are not physically and electrically coupled to the motherboard 300.

Those skilled in the art will appreciate that the logic levels discussed herein are matters of design discretion and could be readily reversed without departing from the spirit and scope of the instant invention. For example, the line 412 could be readily configured to pull the line 408 to a logically high state, which could be used to enable the transmit buffer 502 by virtue of an inverter circuit.

In the illustrated embodiment, the computer system 200 includes both hardware and software. At least a portion of the hardware described herein may be replaced by a processing unit programmed to execute software to implement some or all of the functions described herein. In particular, the functions of the repeater 210 described herein may be performed by one or more processing units that may or may not be geographically dispersed.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method for controlling a bus, comprising:
detecting a device coupled to a bus;
driving signals onto the bus in response to detecting the device being coupled to the bus; and
blocking signals from being delivered onto the bus in response to the absence of the device being coupled to the bus.

2. A method, as set forth in claim 1, wherein detecting the device coupled to the bus further comprises detecting a signal generated by a device being electrically coupled to the bus.

3. A method, as set forth in claim 1, wherein detecting the device coupled to the bus further comprises coupling a line to a preselected voltage in response to a device being electrically coupled to the bus.

4. A method, as set forth in claim 1, wherein detecting the device coupled to the bus further comprises physically coupling the device to the bus, wherein the physical coupling includes a connection to a preselected voltage.

5. A method, as set forth in claim 1, wherein blocking signals from being delivered onto the bus in response to the absence of the device being coupled to the bus further comprises disabling a transmitter from delivering signals onto the bus in response to the absence of the device being coupled to the bus.

6. A method, as set forth in claim 1, wherein disabling a transmitter from delivering signals onto the bus in response to the absence of the device being coupled to the bus further comprises providing a signal to a disable input terminal of the transmitter.

7. A method, as set forth in claim 1, wherein driving signals onto the bus in response to detecting the device being coupled to the bus further comprises enabling a transmitter to deliver signals onto the bus.

8. A method, as set forth in claim 1, wherein enabling a transmitter to deliver signals onto the bus further comprises providing a signal to an enable input terminal of the transmitter.

9. An apparatus for controlling a bus, comprising:
means for detecting a device coupled to a bus;
means for driving signals onto the bus in response to detecting the external device being coupled to the bus; and
means for blocking signals from being delivered onto the bus in response to the absence of the device being coupled to the bus.

10. An apparatus for controlling a bus, comprising:
a first printed circuit board having at least one electrically conductive line extending to a first edge connector;
a repeater mounted on the printed circuit board and electrically coupled to the electrically conductive line, the repeater comprising a transmitter having an enable input terminal and an output terminal, the enable input terminal being coupled to the at least one electrically conductive line on the first printed circuit board;
a second printed circuit board having a second edge connector adapted to mate with the first edge connector, at least one terminal of the second edge connector being coupled to a preselected voltage level and to the enable input terminal of the transmitter via the electrically conductive line to enable the transmitter in response to the first and second edge connectors being coupled together.

11. An apparatus, as set forth in claim 10, wherein the first printed circuit board is a motherboard.

12. An apparatus, as set forth in claim 10, wherein the second printed circuit board is a backplane.

13. An apparatus, as set forth in claim 10, wherein the at least one terminal of the second edge connector is coupled to electrical ground.

14. An apparatus, as set forth in claim 10, wherein the first printed circuit board includes a plurality of electrically conductive lines forming a bus thereon and extending to the first edge connector, the repeater includes a plurality of transmitters each having an enable terminal and an output terminal, the output terminals of the transmitters being coupled to the bus on the first printed circuit board, and the enable terminals of the transmitters being coupled together and to the at least one electrically conductive line extending to the first edge connector.

15. An apparatus, as set forth in claim 14, wherein the second printed circuit board includes a first plurality of electrically conductive lines forming a first bus thereon and extending to the first edge connector, wherein the buses on the first and second printed circuit boards are coupled together via the first and second edge connectors.

16. An apparatus, as set forth in claim 15, wherein the second printed circuit board includes second plurality of electrically conductive lines forming a second bus thereon and extending to a third edge connector, wherein the buses on the first and second printed circuit boards are interfaced via a bridge.

17. An apparatus, as set forth in claim 16, including an external device coupled to the second bus.

18. An apparatus, as set forth in claim 17, wherein the second bus on the second printed circuit board extends to third edge connector, and the external device is coupled to the second bus via a fourth edge connector coupled to the third edge connector.
